(19) United States
(12) Patent Application Publication
(10) Pub. No.: US 2017/0291335 A1
(43) Pub. Date: Oct. 12, 2017

(54) DOUBLE-MATERIAL MIXING DIE ASSEMBLY

(71) Applicant: Zhanfeng CHEN, Hunan Province (CN)

(72) Inventor: Zhanfeng CHEN, Hunan Province (CN)

(21) Appl. No.: 15/196,564

(22) Filed: Jun. 29, 2016

(30) Foreign Application Priority Data
Apr. 12, 2016 (CN) 201620317184.9

(51) Int. Cl. B29C 45/13; B29C 45/16

(52) U.S. Cl. CPC B29C 45/13; B29C 45/164

(57) ABSTRACT

The present invention relates to a double-material mixing die assembly, comprising a feeding part and a die part. The die part comprises a material receiving branch pipe, a material injection pipe and a die cavity. Two feeding parts are provided, and discharge ends of the two feeding parts are inserted into feeding ends of the material receiving branch pipes respectively. Two material receiving branch pipes are provided, and the feeding ends of the material receiving branch pipes just face the discharge ends of the feeding parts respectively. A discharge end of the material injection pipe is connected to the die cavity.

### TECHNICAL FIELD

The present invention relates to a field of automatic feeding die assemblies, especially to a double-material mixing die assembly.

### BACKGROUND

During a conventional production process of plastic toys, usually, two or more different plastic raw materials (such as materials different in color or hardness) are mixed and injected into the same die after being heated to be in a viscous-flow state in order to obtain a more colorful product and to improve the properties, such as harness, of the plastic. However, the above injection process has many problems, which often leads to the low rate of finished products. The major problem is about synchronization, i.e. the problem about how to ensure that different plastic raw materials can be kept in a completely viscous-flow state when being injected into a die so that the raw materials can be fully mixed and molded in the die as expected.

### SUMMARY

To solve the technical problem, the present invention provides a mixing die assembly suitable for two raw materials, thereby overcoming the problem that different raw materials cannot keep the same physical state of aggregation when being injected into a die.

To solve the above technical problem, the present invention provides a double-material mixing die assembly, comprising a feeding part and a die part, wherein, the die part comprises a material receiving branch pipe, a material injection pipe and a die cavity. Two feeding parts are provided, and discharge ends of the two feeding parts are inserted into feeding ends of the material receiving branch pipes respectively. Two material receiving branch pipes are provided, and the feeding ends of the material receiving branch pipes just face the discharge ends of the feeding parts respectively. A discharge end of the material injection pipe is connected to the die cavity.

In a preferred embodiment, each feeding part comprises a pipe body, a nozzle and a heat generating member.

The nozzle is disposed at the discharge end of the feeding part and is of a hollow frustum-shaped structure, wherein a round side, with the small diameter, of the nozzle is provided with a discharge opening, and the other side, with the large diameter, of the nozzle is connected to a discharge end of the pipe body.

The heat generating member is disposed at the outer periphery face of the pipe body.

In another preferred embodiment, each feeding part further comprises a propulsion screw, and a front end of the propulsion screw is disposed inside the pipe body.

In another preferred embodiment, the propulsion screw comprises a thread groove disposed at the outer periphery face of the propulsion screw, and the diameter of the groove decreases from the feeding end to the discharge end.

In another preferred embodiment, each feeding part further comprises a motor. The motor is connected to the rear end of the propulsion screw and drives the propulsion screw to rotate inside the pipe body.

In another preferred embodiment, each feeding part further comprises a feeding hopper. The feeding hopper is disposed above and connected to the pipe body.

In another preferred embodiment, a joint of the feeding hopper and the pipe body is disposed above the thread groove.

In another preferred embodiment, each feeding part further comprises a check valve. The check valve is disposed at a connection of the pipe body and the nozzle.

The double-material mixing die assembly of the present invention has the following advantages:

Compared with the prior art, the double-material mixing die assembly according to the present invention is suitable for two raw materials, and especially can solve the problem that different raw materials cannot keep the same physical state of aggregation when being injected into a die. Through the two feeding parts, two raw materials in a viscous-flow state are separately injected into the feeding ends of their respective material receiving branch pipes at the same time, further gather in the material injection pipe to be mixed, and then are injected into the die cavity.

Preferably, glass-state plastic particles can be heated by the heat generating member to be in the viscous-flow state.

Preferably, the two plastic raw materials in the viscous-flow state are separately pushed by the respective propulsion screws disposed in the respective pipe bodies and driven by the respective motors to flow toward the nozzles on the front ends of the respective pipe bodies.

Preferably, push effect of the propulsion screw is achieved by means of the peripheral thread groove. The diameter of the thread groove decreases from the feeding end to the discharge end so that the pressure of the plastic in the viscous-flow state can becomes higher when the plastic is flowing closer to the discharge end.

Preferably, the discharge end of each pipe body is provided with a frustum-shaped nozzle which enables the pressure of the plastic in viscous-flow state in the nozzle to become higher quickly. By this way, the plastic in the viscous-flow state is injected from the nozzles into the material receiving branch pipes, and then the whole material feeding and mixing process is accelerated.

Preferably, each feeding part is provided with the feeding hopper, through which glass-state plastic raw material is added. A joint of the feeding hopper and the pipe body is disposed above the thread groove, so raw material entering the pipe body can be quickly taken away by the thread groove.

Preferably, a check valve is disposed at a connection of the pipe body and the nozzle, thereby preventing backflow of the plastic in the viscous-flow state at the front end of the pipe body and maintaining the pressure at the nozzle.

### BRIEF DESCRIPTION OF THE DRAWING

FIG. 1 is a perspective top view of a double-material mixing die assembly according to the present invention.

### DETAILED DESCRIPTION

Preferred embodiments of the present invention will be described below in detail with reference to the accompanying drawing.

### Embodiment 1

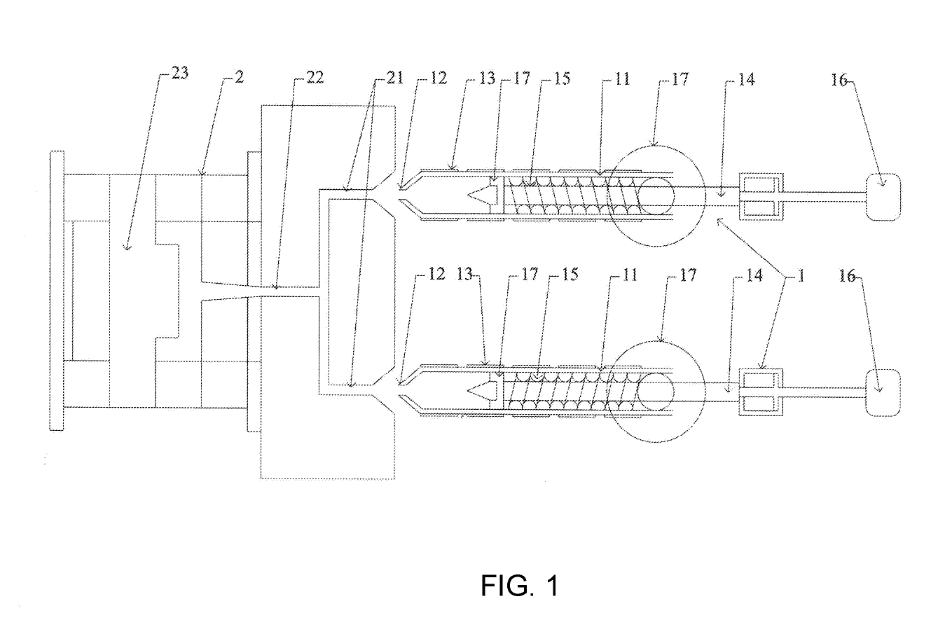

As shown in the FIG. 1, the double-material mixing die assembly according to the present invention comprises a feeding part 1 and a die part 2, wherein the feeding part 1 comprises a pipe body 11, a nozzle 12, a heat generating member 13, a propulsion screw 14 and a motor 16. The die part 2 comprises a material receiving branch pipe 21, a material injection pipe 22 and a die cavity 23.

Two such feeding parts 1 are provided. Discharge ends of the two feeding parts 61 are inserted into feeding ends of the material receiving branch pipes 21 respectively.

The nozzle 12 is disposed at the discharge end of the feeding part 1. Each nozzle 2 is of a hollow frustum-shaped structure, wherein a round side, with the small diameter, of each nozzle is provided with a discharge opening, and the other side, with the large diameter, of each nozzle is connected to a discharge end of the corresponding pipe body 11.

The heat generating member 13 is disposed at the outer periphery face of the pipe body.

The front end of each propulsion screw 14 is disposed inside the pipe body 11. The propulsion screw 14 comprises a thread groove 15. The thread groove 15 is disposed at the outer periphery face of the propulsion screw 14, and the diameter of the groove decreases from the feeding end to the discharge end.

The motor 16 is connected to the rear end of the propulsion screw 14 and drives the propulsion screw 14 to rotate inside the pipe body 11.

Two such material receiving branch pipes 21 are provided, and the feeding ends of the material receiving branch pipes 21 just face the discharge ends of the feeding parts 1 respectively.

The discharge end of the material injection pipe 22 is connected to the die cavity 23.

### Embodiment 2

On the basis of the embodiment 1, as shown in the FIG. 1, each feeding part 1 further comprises a feeding hopper 17, and each feeding hopper 17 is disposed above and connected to the corresponding pipe body 11.

A joint of each feeding hopper 17 and the corresponding pipe body 11 is disposed above the corresponding thread groove 15.

### Embodiment 3

On the basis of the embodiment 2, as shown in the FIG. 1, each feeding part 1 further comprises a check valve 18, wherein the check valve 18 is disposed at a connection of the pipe body 11 and the nozzle 12.

### Embodiment 4

On the basis of the above embodiments, the double-material mixing die assembly may operate in the following way:

Firstly, prepared raw materials are separately poured into the respective feeding hoppers 17, and the heat generating members 13 are turned on to heat the raw materials.

Secondly, when all the raw materials are heated to be in a viscous-flow state, the motors 16 are started to drive the propulsion screws 14 to rotate inside the pipe bodies 11 and to push the plastic in the viscous-flow state to move toward the nozzles 12. Different temperatures in the two pipe bodies can be set according to different raw materials or process requirements.

Thirdly, the raw materials in the viscous-flow state are separately injected from the respective nozzles 12 into the respective material receiving branch pipes 21, and then gather together in the material injection pipe 22 to be mixed.

Fourthly, the fully mixed raw materials are injected from the material injection pipe 22 into the die cavity 23. After a period of time of solidification, the die is opened automatically and a finished product is obtained.

The above described is merely preferred embodiments of the present invention, and not exemplified to intend to limit the present invention. Any modifications and changes without departing from the scope of the spirit of the present invention are deemed as within the scope of the present invention.

1. A double-material mixing die assembly, comprising a feeding part and a die part, the die part comprising a material receiving branch pipe, a material injection pipe and a die cavity, characterized in that:
two feeding parts are provided, and discharge ends of the two feeding parts are inserted into feeding ends of the material receiving branch pipes respectively;
two material receiving branch pipes are provided, and the feeding ends of the two material receiving branch pipes just face the discharge ends of the feeding parts respectively;
discharge ends of the two material receiving branch pipes are connected to a feeding end of the material injection pipe; and a discharge end of the material injection pipe is connected to the die cavity.

2. The die assembly according to claim 1, wherein each feeding part comprises a pipe body, a nozzle and a heat generating member;
the nozzle is disposed at the discharge end of the feeding part and is of a hollow frustum-shaped structure; a round side, with the small diameter, of the nozzle is provided with a discharge opening, and the other side, with the large diameter, of the nozzle is connected to a discharge end of the pipe body; and
the heat generating member is disposed at the outer periphery face of the pipe body.

3. The die assembly according to claim 2, wherein each feeding part further comprises a propulsion screw, and a front end of the propulsion screw is arranged inside the pipe body.

4. The die assembly according to claim 3, wherein the propulsion screw comprises a thread groove disposed at the outer periphery face of the propulsion screw, and the diameter of the groove decreases from the feeding end to the discharge end.

5. The die assembly according to claim 4, wherein each feeding part further comprises a motor, and the motor is connected to the rear end of the propulsion screw and drives the propulsion screw to rotate inside the pipe body.

6. The die assembly according to claim 5, wherein each feeding part further comprises a feeding hopper disposed above and connected to the pipe body.

7. The die assembly according to claim 6, wherein a joint of the feeding hopper and the pipe body is disposed above the thread groove.

8. The die assembly according to claim 7, wherein each feeding part further comprises a check valve disposed at a connection of the pipe body and the nozzle.
